(19) United States
(12) Patent Application Publication
(10) Pub. No.: US 2010/0071219 A1
(43) Pub. Date: Mar. 25, 2010

(54) CUTTER OF A JUICER

(76) Inventor: Kuan-Chih LIN, Tainan Hsien (TW)

Correspondence Address: Kuan-Chih LIN, P.O. BOX8-71, Tainan, 71052, TW

(21) Appl. No.: 12/234,718

(22) Filed: Sep. 22, 2008

(51) Int. Cl. B02C 18/18; B02C 18/08

(52) U.S. Cl. 30/300; 99/510; 30/303

(57) ABSTRACT

The cutter of a juicer includes a cutter set provided with a first cutter and a second cutter. The first cutter has its opposite ends respectively slanting to one side of the diagonal edges and forming an upward cutting member having their diagonal edges respectively formed with a cutting edge and their outer ends respectively bent upward to form a flow-guiding wall with a cutting edge at a diagonal edge. The second cutter is S-shaped and positioned over the first cutter, having the diagonal edges of its opposite sides respectively provided with a cutting edge. The first and the second cutter are secured on a rotating shaft, and an included angle between the first and the second cutter is less than 60 degrees. Vegetable and fruit can quickly and evenly be cut and crushed into juice by the cutter set rotating at high speed.

### BACKGROUND OF THE INVENTION

1. Field of the Invention

This invention relates to the cutter of a juicer, particularly to one provided with a cutter set driven to rotate and able to quickly and evenly crush and stir vegetable and fruit into juice.

2. Description of the Prior Art

A conventional juicer 1, as shown in FIG. 1, includes a base 10, a bowl 11 movably assembled on the base 10, an upper cutter 12 and a lower cutter 13 combined together. The upper cutter 12 bent upward and the lower cutter 13 bent downward are positioned in the interior of the bowl 11. The base 10 is installed therein with a motor and a correlative circuit and mechanism to drive the upper cutter 12 and the lower cutter 13 in the bowl 11 to rotate for cutting and crushing the vegetable and fruit in the bowl 11. However, the upper cutter 12 and the lower cutter 13 of the conventional juicer 1 are positioned perpendicularly to each other and respectively bent upward and downward, and the inner lower side of the bowl 11 is a flat surface; therefore, when put onto the lower side of the bowl 11, the vegetable and fruit with little frictional force will be rotated together with the upper and the lower cutter 12, 13, impossible to be effectively cut into very small pieces by the upper and the lower cutter 12, 13. Thus, the vegetable and fruit can hardly be crushed thoroughly, likely to leave comparatively big dregs. If the vegetable and fruit in the bowl 11 are crushed and stirred for a comparatively long time, the vegetable and fruit will lose their vitamins.

### SUMMARY OF THE INVENTION

The objective of this invention is to offer the cutter of a juicer, able to quickly and evenly cut and crush vegetable and fruit into juice.

The feature of this invention is a cutter set provided with a first cutter and a second cutter. The first cutter has its opposite ends respectively slanting to one side of a diagonal edge and forming a little upturned cutting member, and the two cutting members have their diagonal edges respectively formed with a cutting edge and their outer ends respectively bent upward to form a flow-guiding wall provided with a cutting edge at a diagonal edge. The second cutter is S-shaped and fixed over the first cutter, having the diagonal edges of its opposite sides respectively disposed with a cutting blade. The first and the second cutter are firmly mounted on a rotating shaft.

### BRIEF DESCRIPTION OF DRAWINGS

This invention will be better understood by referring to the accompanying drawings, wherein:

FIG. 1 is a perspective view of a conventional juicer;

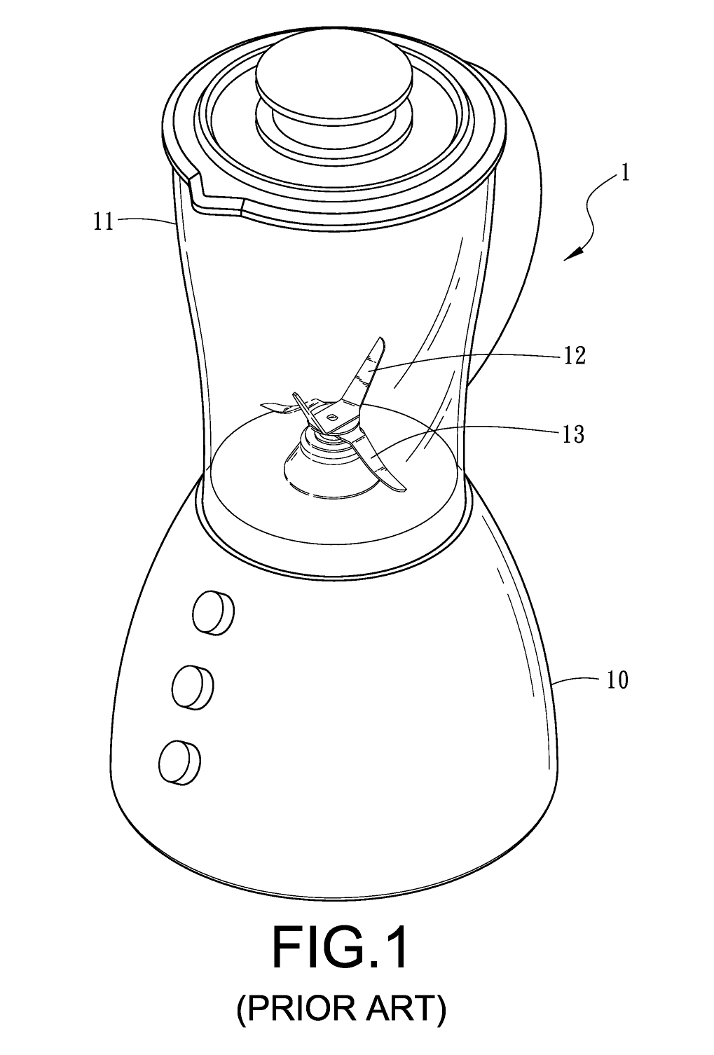

FIG. 2 is a perspective view of a first preferred embodiment of a cutter fixed in a juicer in the present invention;

FIG. 3 is a perspective view of the first preferred embodiment of the cutter in the present invention;

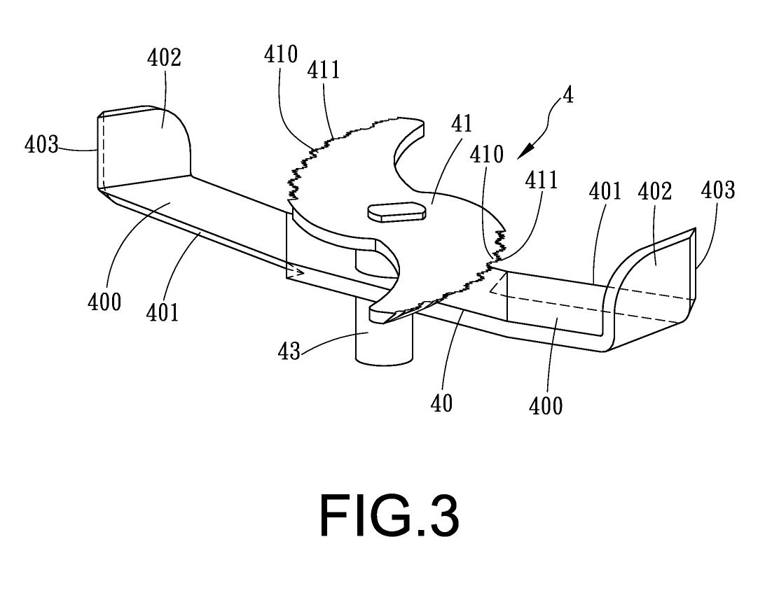

FIG. 4 is an upper view of the first preferred embodiment of the cutter fixed in a juicer in the present invention;

FIG. 5 is a cross-sectional view of the first preferred embodiment of the cutter fixed in a juicer in an operating condition in the present invention;

FIG. 6 is a perspective view of a second preferred embodiment of the cutter fixed in a juicer in the present invention;

FIG. 7 is a perspective view of the second preferred embodiment of the cutter in the present invention;

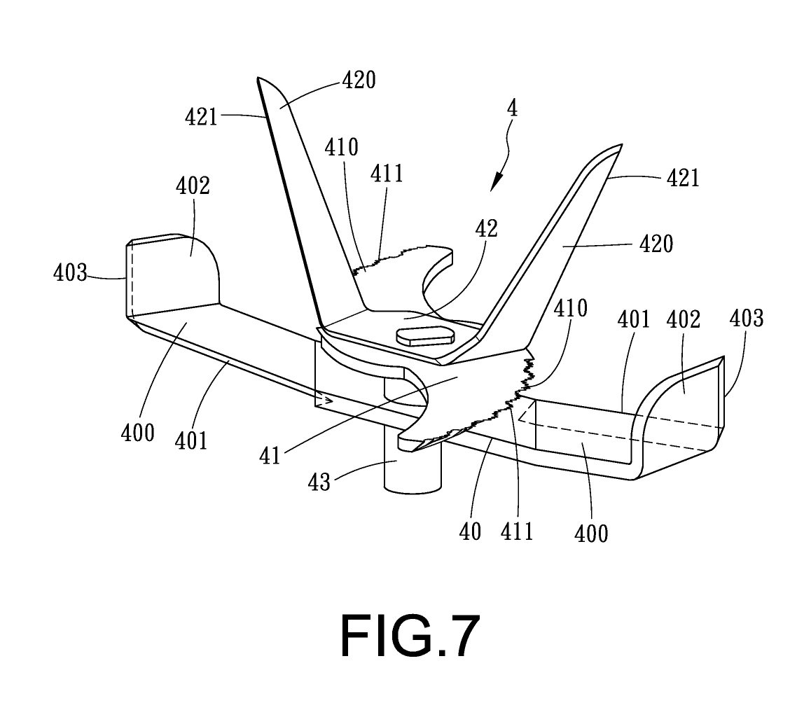

FIG. 8 is an upper view of the second preferred embodiment of the cutter fixed in a juicer in the present invention; and

FIG. 9 is a cross-sectional view of the second preferred embodiment of the cutter fixed in a juicer in an operating condition in the present invention.

### DETAILED DESCRIPTION OF THE PREFERRED EMBODIMENT

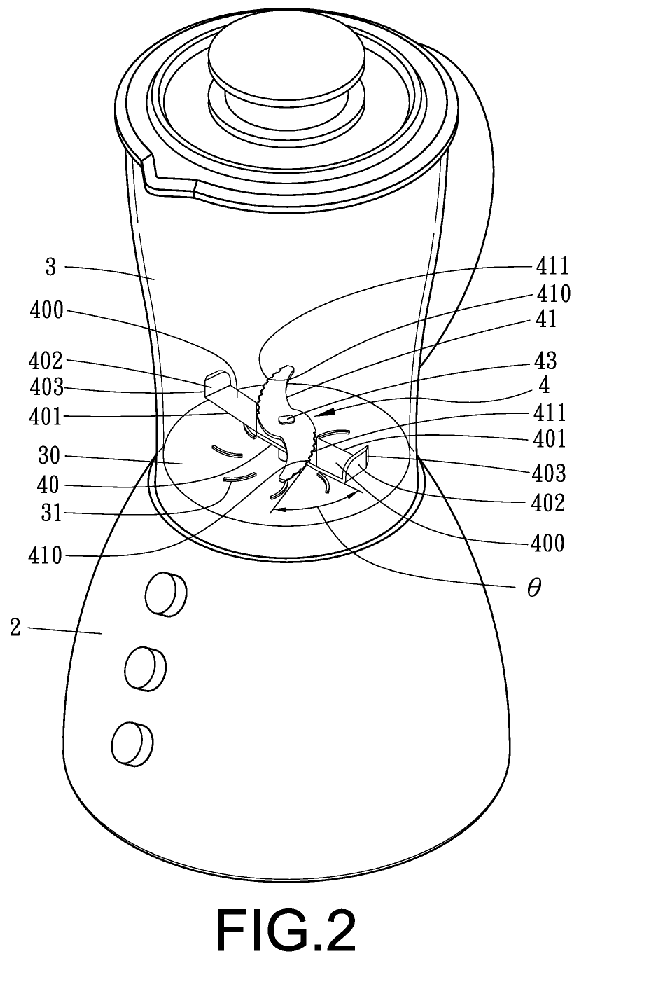

A first preferred embodiment of the cutter of a juicer in the present invention, as shown in FIGS. 2˜5, includes a base 2, a bowl 3 and a cutter set 4 combined together.

The base 2 is provided therein with a motor and a correlative circuit and mechanism (not shown), which are the transmission mechanism installed in the interior of a common juicer.

The bowl 3 is to be movably assembled on the base 2, having its inner lower side 30 disposed thereon with a plurality of eddy-shaped projecting bars 31.

The cutter set 4 is installed on the bottom 30 of the bowl 3, provided with a first cutter 40 and a second cutter 41. The first cutter 40 has its opposite ends respectively slanting to one side of the diagonal edges and forming a little upturned cutting member 400. The two cutting members 400 at the opposite ends of the first cutter 40 have their diagonal edges respectively formed with a cutting edge 401 and their outer ends respectively bent upward to form a flow-guiding wall 402 disposed with a cutting edge 403 at a diagonal edge. The second cutter 42 is S-shaped and positioned over the first cutter 40, having the diagonal edges of its opposite sides respectively formed with a cutting blade 410 provided with a serrated cutting edge 411. The first cutter 40 and the second cutter 41 are firmly fixed on a rotating shaft 43, and an included angle θ formed between the first cutter 40 and the second cutter 41 is between zero degree to 60 degrees.

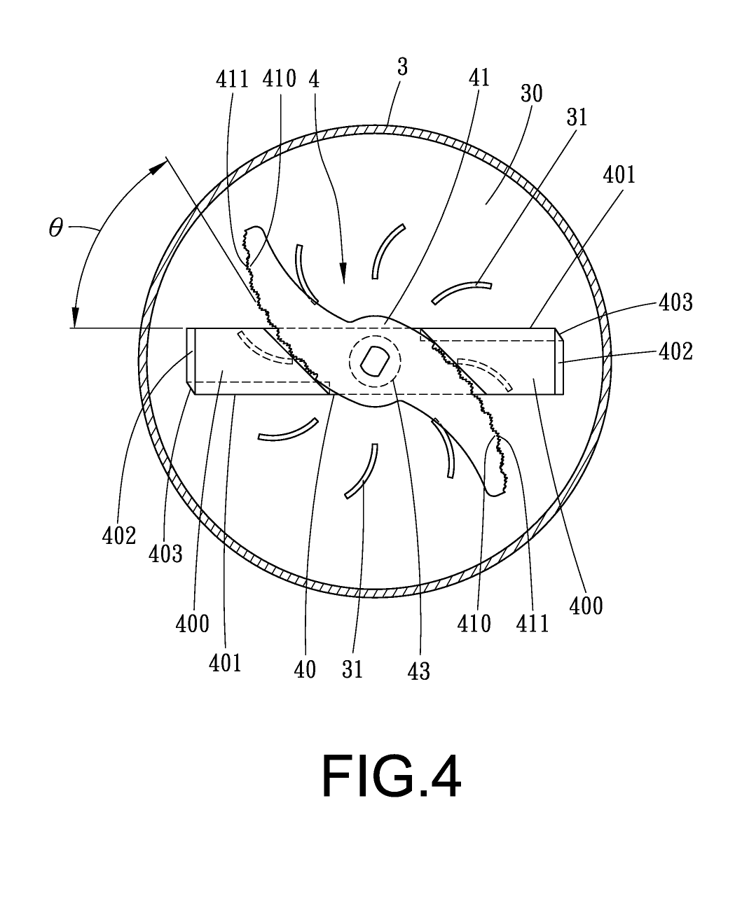

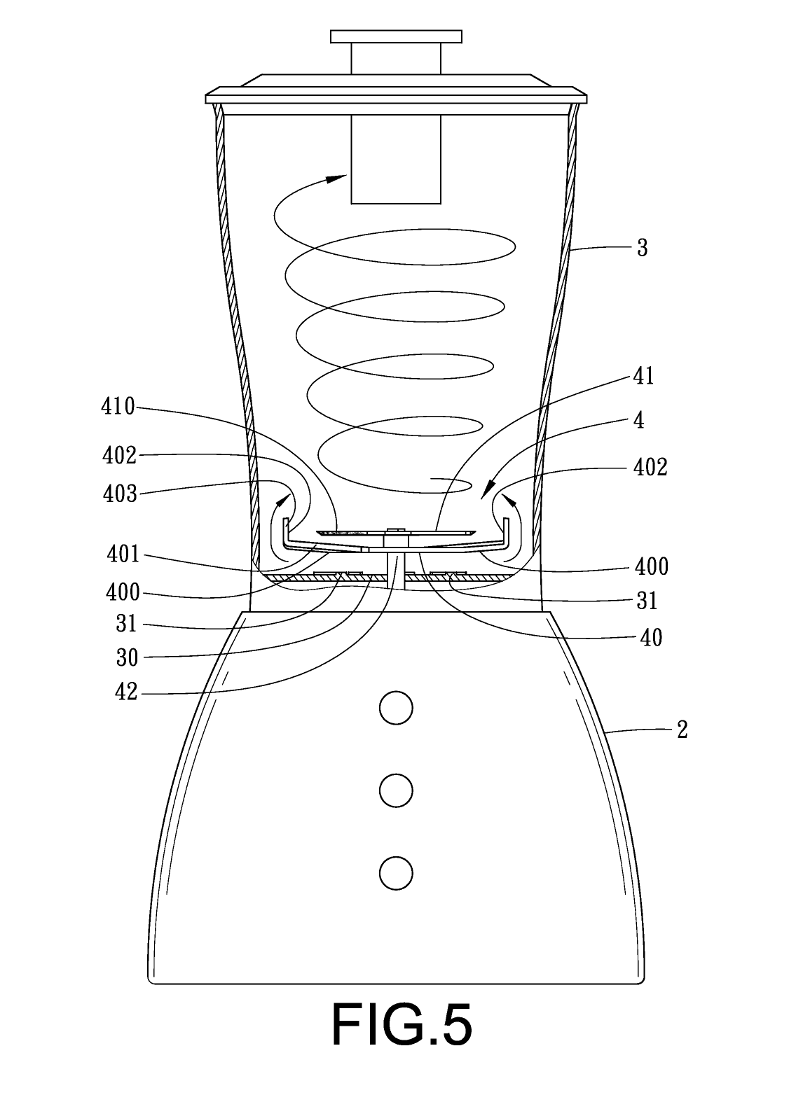

In using, referring to FIGS. 4 and 5, firstly, vegetable and fruit to be beat into juice are put into the bowl 3 and then the motor in the base 2 is started to drive the cutter set 4 to rotate counterclockwise to have the cutting edges 401 and 403 of the first cutter 40 cutting and crushing the vegetable and fruit in the bowl 3. Synchronously, the serrated cutting blades 410 of the second cutter 41 will transversely mince, saw, whittle and cut the vegetable and fruit to quickly and evenly crush them into juice through the space of the included angle θ (0˜60 degrees) between the second and the first cutter 41 and 42. Simultaneously, the vegetable and fruit will be turned over upward and crushed by the flow-guiding walls 402 at the opposite ends of the first cutter 40. Meanwhile, the eddy-shaped projecting bars 31 on the lower side 30 of the bowl 3 will function to hold the vegetable and fruit to increase their frictional force so that the cutter set 4 can cut and crush the vegetable and fruit thoroughly. Thus, by high-speed rotation of the cutter set 4 and the projecting bars 31 on the lower side 30 of the bowl 3, a swirling eddy current will be formed in the interior of the bowl 3 to push upward and move downward the vegetable and fruit circularly to enable them to be beat repeatedly. The included angles θ formed between the first cutter 40 and the second cutter 41 are respectively formed with various cutting angles, able to quickly and evenly cut and beat the vegetable and fruit into juice without leaving any large dregs.

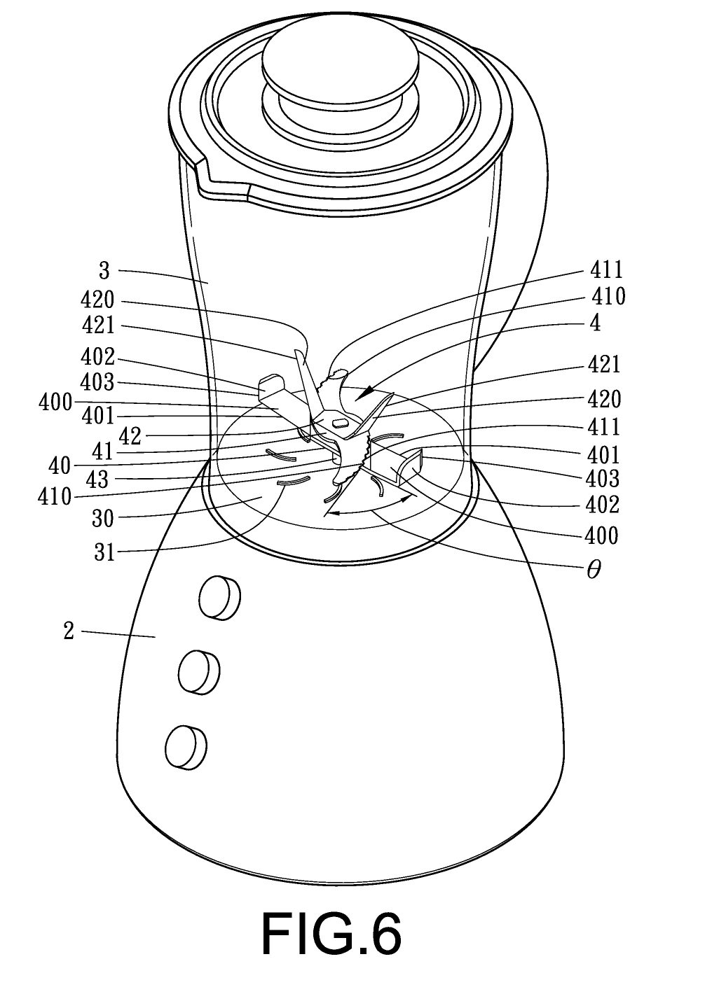

A second preferred embodiment of the cutter of a juicer in the present invention, as shown in FIGS. 6˜9, includes a base 2, a bowl 3 and a cutter set 4 combined together.

The base is installed therein with a motor and a correlative circuit and mechanism (not shown), which are transmission mechanism provided in the interior of a common juicer.

The bowl 3 to be movably mounted on the base 2 has its inner bottom surface 30 fixed thereon with a plurality of eddy-shaped projecting bars 31.

The cutter set 4 installed on the bottom of the bowl 3 is composed of a first cutter 40, a second cutter 41 and a third cutter 42. The first cutter 40 has its opposite ends respectively slanting to one side of the diagonal edges and forming a little upturned cutting member 400. The two cutting members 400 at the opposite ends of the first cutter 40 have their diagonal edges respectively formed with a cutting edge 401 and their outer ends respectively bent upward and formed with a flow-guiding wall 402 disposed with a cutting edge 403 at a diagonal edge. The S-shaped second cutter 41 is assembled over the first cutter 40 and has the diagonal edges of its opposite sides respectively formed with a cutting blade 410 provided with a serrated cutting edge 411. The third cutter 42 is positioned over the second cutter 41, having its opposite ends respectively turned upward to form a bending member 420 and the diagonal edges of the two bending members 420 respectively formed with a cutting edge 420. The first cutter 40, the second cutter 41 and the third cutter 42 are firmly assembled on a rotating shaft 43. The included angle θ formed between the second cutter 41 and first cutter 40 is between zero degree to 60 degrees, while the third cutter 42 and the first cutter 40 are positioned in parallel.

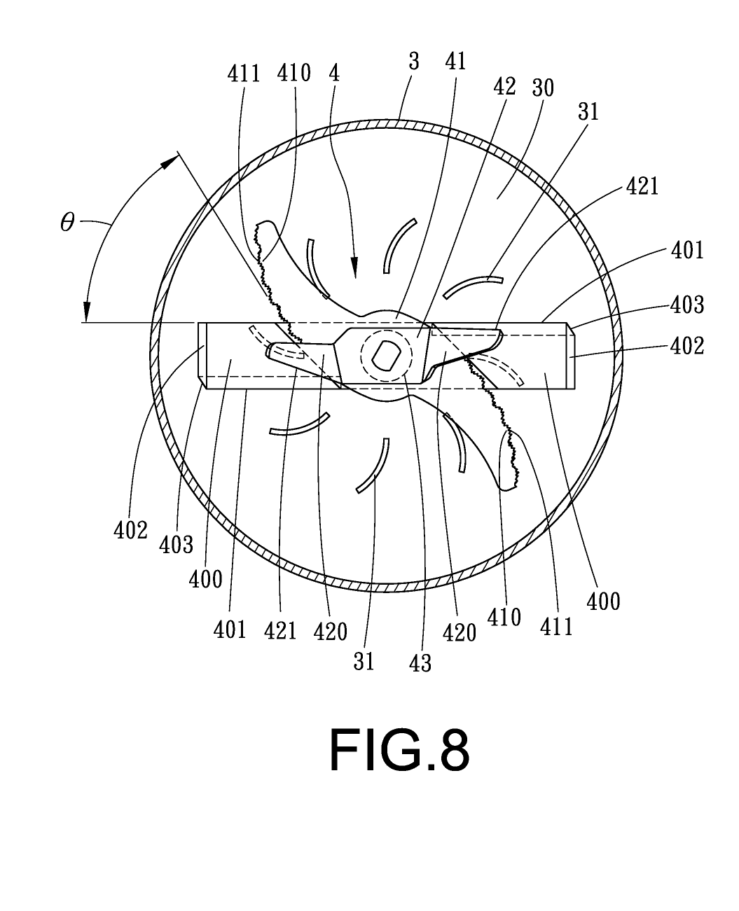

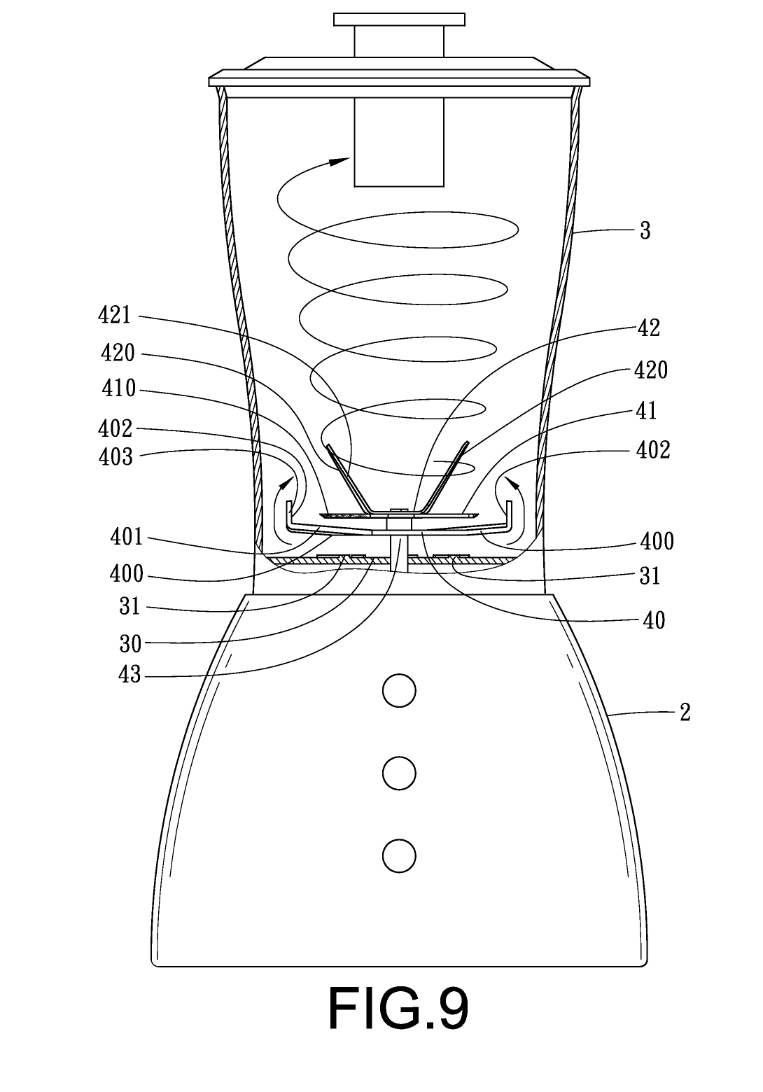

In using, referring to FIGS. 8 and 9, firstly, put vegetable, fruit or food into the bowl 3 and then start the motor in the base 2 to drive the cutter set 4 to rotate counterclockwise so that the vegetable and fruit may be cut into small pieces and crushed by the cutting edges 421 of the third cutter 42, and simultaneously minced and sawed by the serrated cutting blades 410 of the second cutter 41. Thus, the vegetable and fruit can be quickly and evenly crushed into juice through the space of the included angles θ (zero degree to 60 degree) formed between the second cutter 41 and the first cutter 40 and by the third cutter 42 and the first cutter 40 that are positioned in parallel. In addition, the flow-guiding walls 402 at the opposite ends of the first cutter 40 and the bending members 420 of the third cutter 42 will function to turn and stir upward the vegetable and fruit, and the eddy-shaped projecting bars 31 on the bottom surface 30 of the bowl 3 will function to hold the vegetable and fruit to step up their frictional force so that the vegetable and fruit can completely be cut and crushed by the cutter set 4. Thus, by high-speed rotation of the cutter set 4 and the eddy-shaped projecting bars 31 on the bottom surface 30 of the bowl 3, a swirling eddy current will be formed in the interior of the bowl 3 to push upward and move downward the vegetable and fruit circularly, enabling them to be crush repeatedly. Specifically, the included angles θ formed between the first and the second cutter 40 and 41, and the parallel positioned third cutter 42 and first cutter 40 are provided with various cutting angles, able to quickly and completely cut and crush the vegetable and fruit into juice without leaving any dregs.

While the preferred embodiments of the invention have been described above, it will be recognized and understood that various modifications may be made therein and the appended claims are intended to cover all such modifications that may fall within the spirit and scope of the invention.

What is claimed is:

1. The cutter of a juicer comprising a base, a bowl assembled on said base, and a cutter set installed at inner lower side of said bowl: and,
characterized by said cutter set consisting of a first cutter and a second cutter, said first cutter having its opposite ends respectively slanting to one side of a diagonal edge and forming a little upturned cutting member, said two cutting members having their diagonal edges respectively formed with a cutting edge, said two cutting members having their outer ends respectively bent upward to form a flow-guiding wall, said two flow-guiding walls having their diagonal edges respectively disposed with a cutting edge, said second cutter shaped as an S and positioned over said first cutter, said second cutter having diagonal edges of its opposite sides respectively provided with a cutting blade, said first cutter and said second cutter secured on a rotating shaft.

2. The cutter of a juicer as claimed in claim 1, wherein said bowl has its inner lower side fixed thereon with plural eddy-shaped projecting bars.

3. The cutter of a juicer as claimed in claim 1, wherein an included angle between said first cutter and said second cutter is less than 60 degrees.

4. The cutter of a juicer as claimed in claim 1, wherein said cutting blade of said second cutter is formed with a serrated cutting edge.

5. The cutter of a juicer as claimed in claim 1, wherein a third cutter is mounted over said second cutter and has its opposite ends respectively turned upward to form a bending member, said two bending members are respectively formed with a cutting edge at their diagonal edges, and said third cutter and said first cutter are positioned in parallel.
